(19) United States
(12) Patent Application Publication
(10) Pub. No.: US 2020/0391144 A1
(43) Pub. Date: Dec. 17, 2020

(54) FILTER UNIT AND FILTRATION SYSTEM

(71) Applicant: GERUM GmbH, Salzburg (AT)

(72) Inventor: Konstantin GERGANOFF, München (DE)

(21) Appl. No.: 16/902,457

(22) Filed: Jun. 16, 2020

(30) Foreign Application Priority Data
Jun. 17, 2019 (EP) 19 180 450.9

(51) Int. Cl. B01D 33/27; B01D 39/08; B01D 33/46

(52) U.S. Cl. CPC B01D 33/27; B01D 33/463; B01D 39/083; B01D 39/086

(57) ABSTRACT

The filter unit for filtering a liquid comprises a carrier, which is rotatably supported around a rotational axis and comprises a plurality of carrier segments arranged around its circumference. In each carrier segment, two first screen elements are arranged in such a way that they extend outward from the circumference of the carrier and approach each other with increasing distance from the circumference of the carrier in the radial direction relative to the rotational axis. In each carrier segment, furthermore, a second screen element is arranged, which extends substantially along the circumference of the carrier, so that the two first screen elements and the second screen element of a carrier segment are arranged substantially in the form of a triangle. A pore size of the second screen element is larger than a pore size of the first screen elements.

### FIELD OF THE INVENTION

The present invention relates to a filter unit for filtering a liquid and to a filtration system comprising such a filter unit.

Filter units or filtration systems filter solid objects, particles, and suspended solids from a liquid to be filtered. They are used in, for example, clarification plants (especially as the third and usually as the last purification stage), drinking water installations, and in industrial applications such as those for recovering materials from liquids or for filtering cooling water. It is also possible to use a filter unit or filtration system to remove algae from water or to process drinking water.

For example, a filtration system with a filter unit which is arranged in a basin and which comprises a carrier, on the circumference of which a plurality of screen elements are arranged, is known from EP 3 391 949 A1. The carrier is rotatably supported around a feed pipe, which supplies the raw water to be purified. The raw water to be purified is fed to the filter unit radially inside the screen elements and flows through the screen elements into the basin surrounding the filter unit. To increase the surface area available for filtering, the screen elements of the filter unit are arranged in pairs in such a way that the two screens of a pair extend outward from the circumference of the carrier and meet at an outward-pointing apex. The filter unit thus has the shape of a star.

However, if the screen elements become fouled, the efficiency of the system decreases, and in addition the screen elements are subjected to heavy loads, especially when the pressure difference between the feed and the basin or a drain from the basin increases as a result of the fouling. If a screen element is torn, contaminated liquid, which has yet to be filtered, reaches the basin (clean water area) surrounding the filter unit and contaminates the liquid present there, i.e., liquid which has already been filtered.

### SUMMARY OF THE INVENTION

It is an object of the present invention to provide an efficient and particularly reliable filter unit or filtration system.

According to an aspect of the invention, a filter unit for filtering a liquid comprises a carrier, which is rotatably supported around a rotational axis, and a plurality of carrier segments arranged around the circumference of the carrier. Two first screen elements are arranged in each carrier segment of the plurality of carrier segments in such a way that they extend outward from the circumference of the carrier and approach each other with increasing distance from the circumference of the carrier in the radial direction relative to the rotational axis. In addition, a second screen element is arranged in each carrier segment of the plurality of carrier segments. This second screen element extends substantially along the circumference of the carrier, so that the two first screen elements and the second screen element of a carrier segment are arranged substantially in the form of a triangle. A pore size of the second screen element is larger than a pore size of the first screen element.

A filter unit is thus provided in which a second screen element, coming first in the radial direction relative to the rotational axis, is provided to filter out larger solid objects, particles, and suspended solids from the liquid before this liquid arrives at the first screen elements. The load on the first screen elements is thus relieved, as a result of which their service lives can be prolonged and the flow rate increased. The safety of the filter unit is also increased, because, if one of the second screen elements is torn by the action of large particles, the liquid will still be filtered by the first screen elements. No unfiltered liquid can therefore pass into the basin surrounding the filter unit. The first screen elements are arranged substantially in a star-like manner to increase the surface area available for filtering. It is also possible for the liquid to be purified to enter the filter unit at a high-er flow pressure.

The first and second screen elements are configured and attached to the carrier in such a way that, as the liquid flows from an inlet arranged radially inside the first and second screen elements relative to the rotational axis into a basin arranged radially outside the screen elements, it passes through at least a second and a first screen element. The filter unit is sealed in such a way that a liquid stream cannot flow radially from inside the screen elements to radially outside the screen elements except by passing through the screen elements.

Each first and each second screen element can be configured as a one-piece unit or as a multi-part unit. The first screen elements of a carrier segment can also be formed by a single screen element with appropriately arranged sections. Instead of providing a separate second screen element in each carrier segment, a common second screen element can xtend over several carrier segments arranged next to each other in the circumferential direction. The first and second screen elements can, if desired, comprise means for attachment to the carrier or to appropriately designed frame structures.

The carrier preferably comprises a diameter in the range between 0.5 and 2.5 m, preferably between 1.0 m and 2.0 m. The dimensions of the carrier can be adapted to the individual application. It should be taken into account that, as the diameter of the carrier increases, the number of carrier segments and thus of screen elements can be increased, thus making available a larger surface area for filtering. To reduce the amount of space taken up in the radial direction, it is also conceivable that the filter unit could be expanded in the axial direction. For example, several filter units can be arranged axially in a row, one behind the other, or a filter unit can be equipped with several carriers oriented axially with respect to each other, or a carrier can be provided with a plurality of screen elements arranged axially in a row, one behind the other.

The pore size of the first and second screen elements is defined as the diameter of the largest sphere just able to pass through the associated screen element, i.e., through its pores.

To achieve the most thorough possible filtration, the pore size of the first screen elements is, in one embodiment, preferably in the range between 3 μm and 150 μm, more preferably between 5 μm and 100 μm, and even more preferably between 5 μm and 20 μm.

The pore size of a second screen element is preferably in the range between 40 μm and 200 μm, more preferably between 80 μm and 150 μm, so that the corresponding larger particles can be reliably retained by the second screen element and prevented from reaching the first screen elements. The pore size of the second screen elements can also be adapted to the requirements imposed by the concrete application or purpose of use, especially as a function of the pore size of the first screen elements.

It has been found to be especially advantageous for the pore size of the second screen element of a carrier segment to be 2-8 times, preferably 3-6 times, more preferably 3.5-4.5 times the pore size of the first screen elements of the carrier segment.

In a preferred embodiment, the two first screen elements of a carrier segment have the same pore size. As a result, uniform filtration of the liquid to be filtered is achieved. In addition, this also results in a filter unit with an especially simple structure. Through the use of a large number of individual first screen elements with the same pore size, the cost of producing the filter unit can also be reduced.

To obtain screen elements with the most uniform possible configuration and thus to make possible a reliable filtration of particles of a certain size, it is preferred that the pores of the first and second screen elements have a rectangular outline, especially a square outline. The outline is viewed in a cross section parallel to the plane of the associated screen element. In the case of pores with a rectangular outline, the key feature of the pore size is the length of the shorter side of the rectangle.

When the pores are viewed in this way, however, it is also conceivable that one side of the rectangular outline of the pores could be much longer than the length of the side which determines the pore size. It is therefore preferred that the lengths of the sides of the rectangular outline of the pores be only slightly different from each other, and in particular that they should be of the same length in order to avoid the passage of very narrow but long solid objects, particles, and suspended solids. In a preferred embodiment, the pores of the first and second screen elements therefore have a square outline.

The first and second screen elements preferably comprise a fabric. A fabric can be produced relatively easily and with an especially high degree of uniformity, and at the same time provides pores with a rectangular outline for the first and second screen elements. The fabric is preferably formed out of round filaments.

For the possible areas of application of the filter unit, it has been found advantageous for the fabric to be made of stainless steel or of plastic, preferably of acid-resistant plastic which is as tear-proof as possible. Stainless steel is especially strong, hygienic, easy to clean, and easy to handle. Stainless steels such as AISI 316 L can be considered. A plastic fabric can be produced inexpensively, has low weight, and is highly flexible and thus easy to integrate into the filter unit. Polyester, for example, can be used as the plastic. Alternative materials can be selected by the skilled person to suit the demands of the specific application.

In an especially preferred embodiment, a screen frame is arranged in each carrier segment of the plurality of carrier segments. The screen frame has a substantially triangular cross section with an apex directed radially outward relative to the rotational axis and comprises the two first screen elements of the associated carrier segment.

The screen frame serves to hold the two first screen elements and to attach the two first screen elements to the carrier. The two first screen elements can be stretched over the screen frame, and, if required, the frame can reinforce or support the screen elements to protect them from damage. For this purpose, the screen frame can comprise appropriately designed support elements.

The screen frame of a carrier segment preferably also comprises the second screen element of the carrier segment. Thus all of the screen elements of a carrier segment are arranged on the screen frame, which makes it a simple matter to assemble the filter unit.

If the screen frame of a carrier segment is fastened detachably to the carrier, as is preferred, the first screen elements and possibly the second screen element of the carrier segment can be easily removed or replaced. For this purpose, the screen frame can be screwed to the carrier or clamped to the carrier. The skilled person is familiar with alternative connection possibilities, focusing preferably on those which are easy to disconnect.

The first screen elements and optionally the second screen element of a carrier segment can be attached in various ways to the screen frame. Each screen element can, for example, comprises a frame element, which is inserted into the screen frame and connected to it either detachably or nondetachably, as desired. The screen elements themselves can also be connected permanently to the screen frame. For example, screen elements can be bonded to the screen frame with an adhesive or molded as an integral part of it.

The second screen element, alternatively, can also comprise a frame element, by means of which it is attached directly to the carrier. The second screen element can also be integrated into the carrier and form, for example, a part of the circumferential surface of the carrier.

A second screen element is preferably provided in each carrier segment. It is also possible to provide a common second screen element extending over several carrier segments arranged next to each other in the circumferential direction of the carrier. For example, a second screen element can extend over two or more carrier segments. It is also conceivable that a single second screen element could extend around the entire circumference of the carrier and thus extend over all of the carrier segments. The second screen element then forms a part of the circumferential surface of the carrier.

Screen frames arranged next to each other in the circumferential direction of the carrier can abut one another. A seal can be provided between abutting screen frames to prevent the passage of liquid between the screen frames. Each screen frame, however, can also be sealed off in the radial direction relative to the carrier by means of a seal between the screen frame and the carrier.

According to another aspect of the invention, a filtration system for filtering a liquid comprises a filter unit as previously described; a basin for holding a filtered liquid, which basin at least partially surrounds the filter unit; and an inlet for supplying a liquid to be filtered to the filter unit, wherein the inlet is arranged radially inside the first and second screen elements relative to the rotational axis of the carrier of the filter unit.

In this way, a filtration system is provided which benefits from the advantages of the filter unit described above.

Because the inlet is arranged radially inside the screen elements, it is guaranteed that the liquid will flow from the inlet, through the screen elements, and into the basin.

It is obvious that the inlet, to serve its purpose, does not necessarily have to project so far in the axial direction that it is located inside the carrier, which defines a cylinder. Instead, the inlet can also be attached to the filter unit at one of the axial ends of the carrier. For example, the inlet can be flanged to one end of the carrier and thus will not extend into the interior of the carrier. Nevertheless, when considered in the radial direction, the inlet is closer to the rotational axis of the carrier than the screen elements and is therefore located radially inside them.

The filtration system can be configured as a stand-alone unit, especially as a stand-alone tank, or it can be integrated into a clarification plant, for example, so that the basin is formed by, for example, a channel of this plant.

The filtered liquid can be taken from the basin in various ways. For example, the basin can comprise an outlet for draining the filtered liquid from the filtration system. The basin itself, however, can be configured as a pipe or channel for draining out the filtered liquid.

It is preferred that the level of the liquid in the basin and thus in the filter unit be automatically regulated. For this purpose, the filtration system can comprise a control unit and a levelmeasuring device for detecting the level of the liquid or the fill level in the basin or in the partitioned-off zone of the raw water area. The liquid level can then be automatically regulated in particular by the control of the inlet and, if present, of the outlet.

According to an especially preferred embodiment, the filtration system comprises a plurality of cleaning nozzles, preferably spray nozzles, to clean the screen elements and a drain gutter. At least one cleaning nozzle of the plurality of cleaning nozzles is provided to clean the second screen elements. For this purpose, the at least one cleaning nozzle is directed toward at least one second screen element. The at least one cleaning nozzle for cleaning the second screen elements can by formed by a separate cleaning nozzle or by a cleaning nozzle which is also set up to clean at least one first screen element. The cleaning nozzles are preferably supported rigidly in the filtration system, and the screen elements are moved into the working area of the cleaning nozzle, i.e., the area in which the cleaning nozzles are aimed at the screen element in question, by rotation of the carrier around the rotational axis. The cleaning nozzles, however, can also be supported movably, in particular pivotably.

The drain gutter is set up to collect the deposits removed from the screen elements by the plurality of cleaning nozzles and to conduct them out of the filter unit. The drain gutter is arranged radially inside the first and second screen elements relative to the rotational axis of the carrier of the filter unit. The plurality of cleaning nozzles are oriented in such a way that they are aimed at screen elements arranged in an upper half of the filter unit. The drain gutter is preferably located under the screen elements at which the cleaning nozzles are aimed. Deposits removed by the cleaning nozzles then fall downward onto the drain gutter. From there they are carried away from the filter unit.

The at least one cleaning nozzle provided to clean the second screen elements is preferably arranged radially inside the first and second screen elements relative to the rotational axis of the carrier of the filter unit and is attached to the drain gutter. As a result, the at least one cleaning nozzle is aimed directly at the second screen element, without a first screen element being present between the at least one cleaning nozzle and the second screen element. In addition, no additional fastening means are needed inside the filter unit to hold and support this cleaning nozzle. Additional cleaning nozzles of the plurality of cleaning nozzles, especially those for cleaning first screen elements, can be arranged radially outside the first and second screen elements relative to the rotational axis of the carrier of the filter unit and aimed at the first screen elements.

It is also preferred that the maximum liquid level permitted in the filtration system or in the basin be located below the upper edge of the drain gutter. This prevents the deposits removed by the plurality of cleaning nozzles from being flushed back into the liquid to be filtered and from contaminating the screen elements again. Some of the plurality of carrier segments, furthermore, can then be arranged above the liquid level, and it is the screen elements of these carrier segments which will be cleaned by the plurality of cleaning nozzles.

So that the filtration system or the filter unit can achieve an especially high degree of efficiency and offer a sufficiently long period of operational readiness, the carrier rotates at certain intervals to move fouled screen elements into the working area of the cleaning nozzles and to move the clean screen elements back into the liquid to be purified.

For example, the carrier rotates 1-20 times, preferably 2-8 times, per hour. The carrier can rotate in stepwise fashion, so that a certain number of screen elements is in the working area of the cleaning nozzles during each step. After a certain period of time the carrier rotates again, and the screen elements following in the circumferential direction are moved into in the working area of the cleaning nozzles. It is also conceivable that the carrier could rotate continuously for a predetermined time so that all of the screen elements can be cleaned by the cleaning nozzles. For example, the carrier can rotate for 1-2 minutes and then stop. The rotational speed is relatively slow. The filter unit requires preferably a speed in the range of 1.5-2.5 minutes/revolution.

The rotation can occur at predetermined time intervals or can be automatically regulated by the control unit on the basis of operating parameters such as a pressure difference between the inlet and the outlet. An increase in the pressure difference is a sign that the screen elements have become loaded with dirt and must be cleaned. The control unit can initiate the rotation of the carrier when the pressure difference reaches a limit value.

The plurality of cleaning nozzles are preferably formed by spray nozzles. The spray nozzles preferably discharge water jets at a pressure in the range of 0.5-1.0 bars toward the screen elements to be cleaned.

The jet discharged by each of the cleaning nozzles is preferably aimed at an angle in the range of 3−20° to the screen element to be cleaned. This guarantees that the deposits or dirt can be loosened from the screen elements in the most reliable possible fashion without forcing particles through the second screen element toward the first screen elements.

### BRIEF DESCRIPTION OF THE DRAWINGS

FIG. 1 shows a perspective view of essential components of a filtration system according to an embodiment of the invention;

FIG. 2 shows a detailed view, in perspective, of a section of a filter unit according to an embodiment of the invention;

FIG. 3 shows an exploded view of the part of the filter unit illustrated in FIG. 2; and

FIG. 4 shows a cross-sectional view of part of the fabric of a screen element of a filter unit according to an embodiment of the invention.

### DETAILED DESCRIPTION OF SPECIFIC EMBODIMENTS

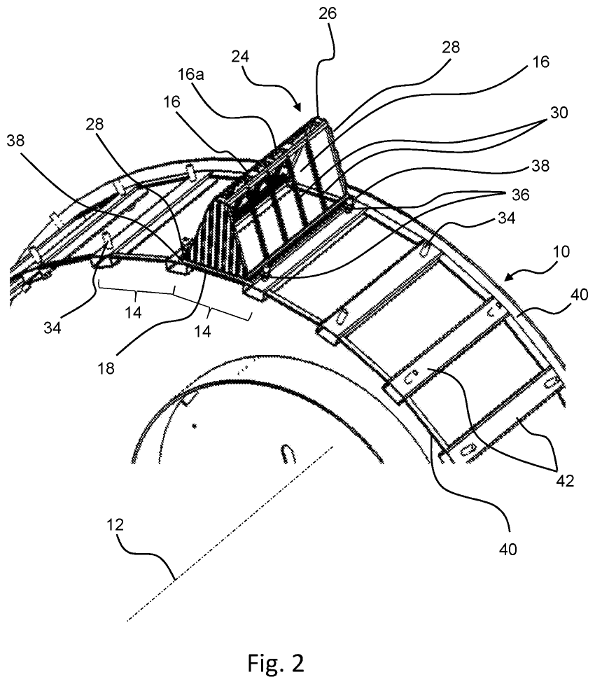

The filtration system 1 comprises a filter unit 2, which is described in greater detail below with additional reference to FIGS. 2-4. The filtration system 1 also comprises a basin 4 to hold the liquid filtered by the filter unit 2. The basin 4 at least partially surrounds the filter unit 2.

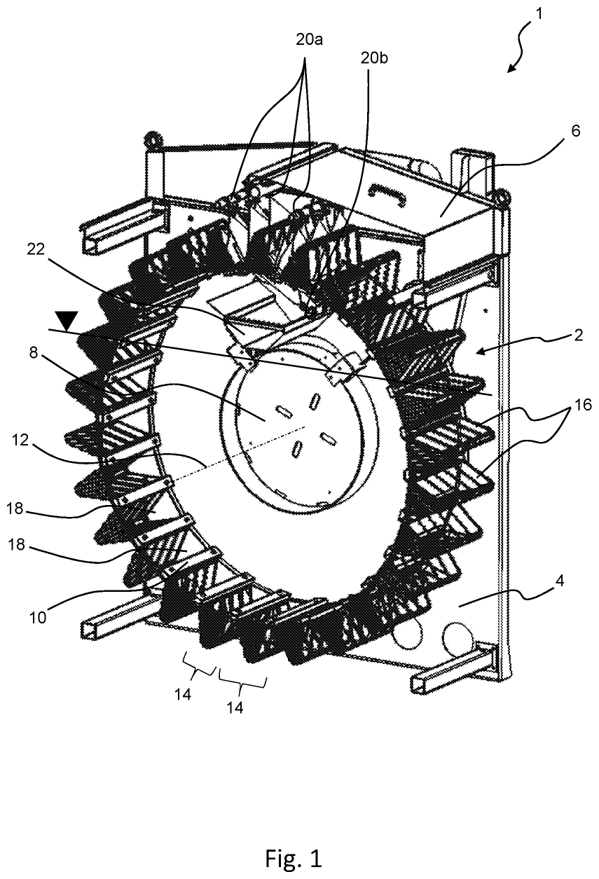

The level ▾ of the liquid in the basin 4 or in the filter unit 2 or in the feed basin is indicated schematically in FIG. 1. The maximum liquid level is preferably such that the filter unit 2 is not completely immersed in the liquid. It can therefore be sufficient for the basin 4 to surround the filter unit 2 only to the extent that a desired liquid level is made possible in the basin 4 or in the filter unit 2. The basin 4 can, for example, be formed by a tank with appropriate side walls (not shown here). The basin 4, however, can also be part of a channel or of a basin of a plant such as a clarification plant.

The filtration system 1 can also comprise one or more covers 6, which cover the basin 4 and shield it from spray water and spray mist. In that case, the filter unit 2 is then surrounded substantially completely by the basin 4 and by at least one cover 6, and the escape of spray water and contaminants during the operation of the filtration system 1 is avoided.

As can be seen especially clearly from a consideration of FIGS. 1-3 in combination, the filter unit 2 comprises a carrier 10, which is rotatably supported around a rotational axis 12. The carrier 10 comprises a plurality of carrier segments 14, arranged around its circumference. The carrier segments 14 do not have to be physically separated from each other by components of the filter unit 2. In each carrier segment 14 are two first screen elements 16, which are arranged in such a way that they extend outward from the circumference of the carrier 10 and approach each other with increasing distance from the circumference of the carrier 10 in the radial direction relative to the rotational axis 12. A second screen element 18 is also arranged in each carrier segment 14. This second screen element 14 extends substantially along the circumference of the carrier 10. The two first screen elements 16 and the second screen element 18 of a carrier segment 14 are arranged to form substantially a triangle. One side of the triangle, i.e., the side which forms an edge of the second screen element 18, extends substantially along the circumference of the carrier 10, whereas the two other sides of the triangle, each of which forms an edge of a first screen element 16, extend from the circumference of carrier 10 outward and form a radially outward-oriented apex.

It can be seen in FIG. 1 that preferably the entire circumference of the carrier 10 is divided into carrier segments 14 and equipped with first and second screen elements 16, 18. As a result, it is possible to obtain the maximum filter surface area relative to the diameter of the carrier 10.

The filtration system 1 also comprises an inlet 8 for supplying a liquid to be filtered to the filter unit 2. The inlet 8 is arranged radially inside the substantially cylindrical filter unit 2. It can be derived from FIG. 1 that the inlet 8 for supplying the liquid to be filtered to the filter unit 2 is arranged radially inside the first and second screen elements 16, 18 relative to the rotational axis 12. The liquid to be filtered passes through the inlet 8 into the filter unit 2, and as the liquid to be filtered flows from the inlet 8 into the basin 4 surrounding the filter unit 2, it passes through at least one second and one first screen element 18, 16. The liquid to be filtered is thus filtered by the first and second screen elements 16, 18.

The pore size of the second screen element 18 is larger than the pore size of the first screen elements 16, as a result of which the larger deposits are retained by the second screen elements 18 as a first step. The liquid, which has thus already been prefiltered, then passes through the first screen elements 16 for further filtration. In comparison to conventional filtration systems, the first screen elements 16 thus become fouled more slowly and are subjected to lighter loads.

The inlet 8 can be flanged to the filtration system 1 at one axial end of the filter unit 2, or, if it is in the form of an inlet pipe, it can extend in the axial direction of the rotational axis 12 into the filter unit 2, in particular into the carrier 10, so that the filter unit 2 surrounds the inlet 8. The filter unit 2 can then be supported rotatably on an inlet pipe of this type. It is preferable, however, for the filter unit 2, i.e., the carrier 10, to be rotatably supported on a machine stand of the filtration system 1.

In the embodiment shown here, the filtration system 1 also comprises a plurality of cleaning nozzles 20a, 20b. Each cleaning nozzle 20a, 20b is set up to clean a first and/or a second screen element 16, 18. The cleaning nozzles 20a, 20b are for this purpose directed at the screen element or screen elements 16, 18 which are arranged in the working area of the cleaning nozzles 20a, 20b at the time in question.

It is preferred that at least one cleaning nozzle 20a for cleaning the second screen elements 18 be arranged radially inside the second screen elements 18 with respect to the rotational axis 12. The at least one cleaning nozzle 20a can then be aimed directly at the second screen element 18 in question to be cleaned without there being a first screen element 16 present between the at least one cleaning nozzle 20a and the second screen element 18 in question. One or more cleaning nozzles 20b for cleaning the first screen elements 16 can be arranged radially outside the first screen elements 16 relative to the rotational axis 12. It is also possible, however, to provide only corresponding cleaning nozzles 20a or 20b arranged radially inside or radially outside the screen elements 16, 18, these being set up to clean both the first and the second screen elements 16, 18. To guarantee the most uniform possible cleaning of the first and second screen elements 16, 18, preferably several cleaning nozzles 20a, 20b are arranged one behind the other in a row parallel to the rotational axis 12.

The filtration system 1 also comprises a drain gutter 22, which is set up to collect the deposits removed by the plurality of cleaning nozzles 20a, 20b from the screen elements 16, 18 and to conduct them out of the filter unit 2. The drain gutter 22 is preferably arranged vertically under the screen elements 16, 18 at which the cleaning nozzles 20a, 20b are aimed so that it can collect the removed deposits.

In the embodiment shown here, the at least one cleaning nozzle 20a for cleaning the second screen element 18 is attached to the drain gutter 22. There is therefore no need to provide any additional fastening means inside the filter unit 2 to hold and support the at least one cleaning nozzle 20a. In addition, the at least one cleaning nozzle 20a can thus be arranged as close as possible to the second screen element 18 to be cleaned.

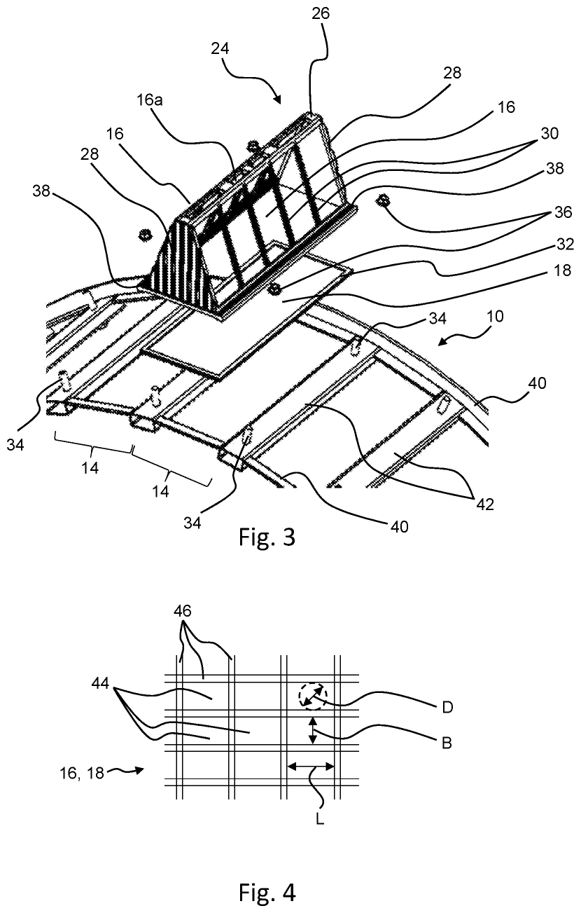

A preferred construction of the filter unit 2 is described below with reference to FIGS. 2 and 3. The filter unit 2, in the preferred embodiment shown, comprises a plurality of screen frames 24. Preferably one screen frame 24 is arranged in each carrier segment 14. A screen frame 24 has a substantially triangular cross section. Once the screen frame 24 is mounted on the carrier 10, the plane of this cross section is perpendicular to the rotational axis 12 of the carrier 10. In this state, the apex 26 of the substantially triangular cross section of the screen frame 24 is also oriented radially outward relative to the rotational axis 12. The screen frame 24 comprises at least the two first screen elements 16 of the associated carrier segment 14. In particular, the two first screen elements 16 are arranged in the two sides of the screen frame 24 extending toward the apex 26 of the screen frame 24.

Each screen frame 24 preferably has the shape of a three-sided prism, in particular a straight, regular prism. The length of the screen frame 24 is defined as its dimension parallel to the rotational axis 12 and is preferably between 100 and 1500 mm, more preferably between 200 and 800 mm, and even more preferably between 400 and 600 mm.

End surfaces 28 of the screen frame 24 are preferably closed, but in an alternative embodiment each of them can be provided with a screen element.

The radially outward-oriented apex 26 of the screen frame 24 can be rounded for flattened and optionally can comprise a screen element 16a to increase the available filter area even more. The screen element 16a can in that case also be cleaned by cleaning nozzles 20a, 20b, and deposits can thus be prevented from adhering to the apex 26 of the screen frame 24. The screen element 16a can be part of one of the two adjacent first screen elements 16 or be formed by a separate screen element 16a.

Each of the two sides of the screen frame 24 which are oriented toward the outside relative to the carrier 10 comprises a first screen element 16. Each first screen element 16 is preferably configured as a one-piece unit and is connected to the screen frame 24. Each first screen element 16, however, can also be formed by a multi-part unit, so that several separate screen element segments are connected to the screen frame 24 in such a way that they form a first screen element 16.

The first screen elements 16 can be connected permanently or detachably to the screen frame 24. For example, the first screen element 16 can be bonded to the screen frame 24 by the use of an adhesive or can be molded integrally with it. The first screen element 16, however, can also comprise a frame element, across which the first screen element is stretched, which frame element is then inserted into the screen frame 24 and connected to it.

The screen frame 24, furthermore, can comprise support elements 30 for supporting the first screen elements 16. For example, the support elements 30 are configured as struts, which begin from a part of the screen frame 24 facing the carrier 10 and extend along the outward-oriented sides of the screen frame 24 to the apex 26. The support elements 30 are preferably arranged outside the first screen element 16. The liquid flowing from the inside to the outside through the first screen element 16 pushes the first screen element 16 against the support elements 30, which resist the pressure exerted by the flow of liquid on the first screen element 16. The first screen element 16 can also be connected to the associated support elements 30 near it.

In an especially preferred embodiment, the two first screen elements 16 and, if present, the screen element 16a at the apex 26, are formed by one and the same screen element, the sections of which are arranged correspondingly. For example, the two first screen elements 16 and the screen element 16a at the apex 26 are formed by a continuous layer of fabric. The two first screen elements 16 and the screen element 16a, however, can also be formed by separate screen elements.

The screen frame 24 of a carrier segment 14 can also comprise the second screen element 18 of this carrier segment 14. As previously described in reference to the first screen elements 16, the second screen element 18 can also be configured as a one-piece or as a multi-piece unit and be connected permanently or detachably to the screen frame 24. The second screen element 18 is arranged on a side of the screen frame 24 facing the carrier 10 and opposite the apex 26. The screen frame 24 can also comprise support elements for supporting the second screen element 18, which are then arranged radially outside the second screen element 18 relative to the rotational axis 12 in order to counteract the pressure of the flow of liquid.

The second screen element 18 can comprise a frame element 32, over which the screen element 18 is stretched. The frame element 32 can be inserted into the screen frame 24 and connected to it. The frame element 32, however, can also be mounted between the screen frame 24 and the carrier 10 or connected directly to the carrier 10 in the associated carrier segment 14. In particular, the second screen element 18 can be attached to the carrier radially outside or radially inside the carrier 10, regardless of whether it is attached to a frame element 32 or lacks a frame element 32.

The second screen element 18 and the screen frame 24 can be installed in an especially simple way by arranging the screen frame 24 on top of the second screen element 18 by placing them on the carrier 10, to which they are then fastened by suitable fastening means. In the embodiment shown, bolts 34, for example, in particular threaded bolts, are provided, which are located at the boundaries between circumferentially adjacent carrier segments 14 of the carrier 10. The second screen element 18, preferably with a frame element 32, and the screen frame 24 are arranged on the carrier 10 between bolts 34 which are adjacent to each other in the circumferential direction of the carrier 10. Nuts 36 are screwed onto the bolts 34, as a result of which the screen frame 24 and the second screen element 18 are held in place on the carrier 10.

The screen frame 24 preferably comprises two flange sections 38, which extend in the longitudinal direction, parallel to the rotational axis 12, and which make it possible, first, to give the carrier 10 a flat contact surface and, second, to form a contact surface for the nuts 36, so that the nuts 36 can hold the screen frame 24 in place on the carrier by way of the flange sections 38. It is also preferred that flange sections 38 of adjacent screen frames 24 be adjacent to the same bolts 34 and held down by the same nuts 36. The installation work and the number of fastening means is thus reduced. Alternatively, the flange sections 38 can have openings, through which the bolts 34 pass. The skilled person is familiar with a wide variety of fastening means adapted to the purpose.

An especially sturdy carrier 10 can be obtained by constructing it out of two ring elements 40, one of which is arranged on each of the two end surfaces of the carrier 10. Between the ring elements 40, a plurality of bars 42 extend in the axial direction. Two adjacent bars 42 preferably form the boundaries of a carrier segment 14. The bolts 34 can be provided on the ring elements 40 and/or on the bars 42.

The screen frame 24, especially its flange sections 38, can rest on the bars 42. The screen frame 24 preferably rests all the way around on the ring elements 40 and on the bars 42 to produce a sealing effect. A gasket is preferably provided on the side of the screen frame 24 facing the carrier 10 to ensure leak-proof contact between the screen frame 24 and the carrier 10.

It is obvious that, in an alternative embodiment, the second screen element 18 can be formed within the scope of the invention in such a way that it extends over several carrier segments 14. For this purpose, the second screen element 18 (with or without a frame element 32) can be preshaped in correspondence with the contour of the carrier 10, or it can have sufficient flexibility to conform to the contour of the carrier 10, or it can be integrated into the carrier 10.

FIG. 4 shows, on an enlarged scale, a section of a screen element 16, 18 to facilitate the description of the pores 44 of the first and second screen elements 16, 18. The pores 44 of the screen element 16, 18 have a rectangular outline. The rectangular outline of each pore 44 is defined by a length L and a width B. The pore size of a pore 44 is defined in turn as the diameter of the largest sphere just able to pass through the pore 44. The largest sphere for the pores 44 shown here is indicated schematically by a circle with the diameter D. In the case of pores 44 with a rectangular outline, therefore, it is always the shorter side, whether L or B, which is the key factor. In the example shown here, this key factor is thus the width B.

It is necessary, however, to prevent narrow particles with a width smaller than the pore size of the pores 44 but with a length greater than the pore size from being able to pass through the associated screen element 16, 18. For this reason, neither the length L nor the width B of rectangular pores 44 is preferably much larger than the selected and predefined pore size of the screen elements 16, 18. It is preferred that the length L be equal to the width B of the pores 44, which means that the pores will have a square outline.

It is especially easily to obtain pores 44 with a rectangular or square outline by forming the first screen element 16 and the second screen element 18 from a fabric, preferably a fabric made from round filaments 46.

Alternative materials and filter fabrics are known to the skilled person in the field in question and can be used equally well for both the first and second screen elements 16, 18.

1. A filter unit for filtering a liquid, comprising:
a carrier, which is rotatably supported around a rotational axis and comprises a plurality of carrier segments arranged around the circumference of the carrier;
wherein in each carrier segment of the plurality of carrier segments, two first screen elements extend outwards from the circumference of the carrier and approach each other with increasing distance from the circumference of the carrier in the radial direction relative to the rotational axis;
wherein in each carrier segment of the plurality of carrier segments, a second screen element is arranged, which extends substantially along the circumference of the carrier, wherein the two first screen elements and the second screen element of each carrier segment are arranged substantially in the form of a triangle; and
wherein a pore size of the second screen element is larger than a pore size of the first screen elements.

2. The filter unit according to claim 1, wherein the pore size of the first screen elements is between 3 μm and 150 μm.

3. The filter unit according to claim 2, wherein the pore size of the second screen elements is between 40 μm and 200 μm.

4. The filter unit according to claim 1, wherein the pore size of the second screen element of a carrier segment is 2-8 times the pore size of the first screen elements of the carrier segment.

5. The filter unit according to claim 1, wherein the two first screen elements of a carrier segment have the same pore size.

6. The filter unit according to claim 1, wherein pores of the first and second screen elements have a rectangular outline.

7. The filter unit according to claim 1, wherein the first and second screen elements comprise a fabric.

8. The filter unit according to claim 7, wherein the fabric is formed out of stainless steel or plastic.

9. The filter unit according to claim 8, wherein the fabric is formed out of round filaments.

10. The filter unit according to claim 1, wherein, in each carrier segment of the plurality of carrier segments, a screen frame is arranged, which has a substantially triangular cross section with an apex pointing outward relative to the rotational axis and which comprises the two first screen elements of the associated carrier segment.

11. The filter unit according to claim 10, wherein the screen frame of the carrier segment also comprises the second screen element of the carrier segment.

12. The filter unit according to claim 10, wherein the screen frame of a carrier segment is fastened detachably to the carrier.

13. A filtration system for filtering a liquid, comprising:
a filter unit comprising:
a carrier, which is rotatably supported around a rotational axis and comprises a plurality of carrier segments arranged around the circumference of the carrier;
wherein in each carrier segment of the plurality of carrier segments, two first screen elements extend outwards from the circumference of the carrier and approach each other with increasing distance from the circumference of the carrier in the radial direction relative to the rotational axis;
wherein in each carrier segment of the plurality of carrier segments, a second screen element is arranged, which extends substantially along the circumference of the carrier, wherein the two first screen elements and the second screen element of each carrier segment are arranged substantially in the form of a triangle; and
wherein a pore size of the second screen element is larger than a pore size of the first screen elements;
an inlet for supplying the liquid to be filtered to the filter unit, wherein the inlet is arranged radially inside the first and second screen elements relative to the rotational axis of the carrier; and
a basin for receiving the filtered liquid, which basin at least partially surrounds the filter unit.

14. The filtration system according to claim 13, further comprising a plurality of cleaning nozzles and a drain gutter;
wherein at least one cleaning nozzle of the plurality of cleaning nozzles is arranged to clean the second screen elements; and
wherein the drain gutter is set up to collect deposits removed by the plurality of cleaning nozzles and to conduct the deposits out of the filter unit.

15. The filtration system according to claim 14, wherein the at least one cleaning nozzle, which is aimed at the second screen element of a carrier segment, is arranged radially inside the first and second screen elements relative to the rotational axis of the carrier of the filter unit.
